(19) United States
(12) Patent Application Publication
(10) Pub. No.: US 2005/0229145 A1
(43) Pub. Date: Oct. 13, 2005

(54) Method and system for chrome cut-out regions on a reticle

(76) Inventors: John H. Irby IV, Hillsboro, OR (US); Linda A. Fraser, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/812,465

(22) Filed: Mar. 29, 2004

(51) Int. Cl. G06F 17/50

(52) U.S. Cl. 716/19

(57) ABSTRACT

A method and system for chrome cut-out regions on a reticle is described. The method includes determining a location of one or more regions on a reticle that come in contact with a reticle handling, storage, or support surface and generating a pattern to be written on the reticle, where the pattern includes one or more cut-out regions that correspond to the one or more regions that come in contact with the reticle handling, storage, or support surface. The pattern may then be written on a reticle blank and developed and etched to remove the reticle surface chrome from the one or more regions that have been determined to come in contact with the reticle handling, storage, or support surface.

### BACKGROUND

1. Technical Field

Embodiments of the invention relate to the field of semiconductor processing, and more specifically to the use of chrome cut-out regions on a reticle.

2. Background Information and Description of Related Art

Surface contamination is a problem for reticles used in semiconductor processing. Since the reticle contains the circuit pattern that will be exposed on wafers, any defects in the reticle will get patterned onto the wafers. Therefore, surface contamination of reticles causes a lower die yield.

Various methods are used to counter surface contamination. One method is to handle reticles in a cleanroom environment having controlled air flow and air filtration. Another method is to minimize the surface area where a reticle comes in contact with reticle handling equipment. A reticle-handling robot arm may grip reticles along the edges to avoid direct contact with a reticle's upper glass and lower chrome surfaces. Another method is to apply pellicles to reticles to shield reticle surfaces from particles.

Reticle handling and storage apparatuses may use materials that help prevent the generation of contaminants. For example, reticle-handling robot arms, internal storage libraries, and reticle stage surfaces are typically constructed of metal, such as aluminum or stainless steel, to prevent outgassing from these surfaces onto the reticle. Reticle pods, reticle carriers used for shipping and storing reticles, and reticle-handling robot arms may also use non-metallic materials at reticle contact points in order to minimize abrasive scratching of the reticle chrome and glass surfaces. Reticle pods, reticle carriers, and reticle-handling robot arms are also typically made of materials that minimize particle generation during normal usage.

Various methods may be used to transport reticles to minimize generation of reticle contaminants or physical damage to reticles. A typical algorithm used for reticle-handling robot arm movement is to complete horizontal positioning of a reticle handling arm above or below the reticle at a safe vertical offset distance, then proceed with vertical movement to make contact with the reticle surface. This method helps prevent reticle surface scuffing. Reticle-handling robot motion control sensors monitored by software algorithms may be used to detect unsafe movement of reticles during transport and trigger a software interlock that immediately stops reticle handling movement.

Even with the use of the methods discussed above, reticle chrome surface degradation in the regions of reticle handling still occur, since conventional reticle handling methods rely on surface contact with the reticle chrome. The deposit of particles on the reticle may induce a localized reticle-leveling focus anomaly during wafer exposure. Reticle chrome surface degradation can induce repeating die defects that may not be detectable by in-line process monitors and thus affect line yields.

### BRIEF DESCRIPTION OF DRAWINGS

The invention may best be understood by referring to the following description and accompanying drawings that are used to illustrate embodiments of the invention. In the drawings:

FIG. 1 illustrates a conventional reticle.

FIG. 2 illustrates a reticle with chrome cutout regions according to an embodiment of the invention.

FIG. 3 illustrates a reticle with chrome cutout regions positioned for contact with a pod lower door surface according to an embodiment of the invention.

FIG. 4 is a flow diagram illustrating a method of design according to an embodiment of the invention.

FIG. 5 is a flow diagram illustrating a method of manufacturing according to an embodiment of the invention.

FIGS. 6a-6d illustrate a reticle in various stages of a manufacturing process using a positive photoresist according to an embodiment of the invention.

FIGS. 7a-7b illustrate drawn CAD data and the resulting reticle pattern using a positive photoresist manufacturing process according to an embodiment of the invention.

FIGS. 8a-8d illustrate a reticle in various stages of a manufacturing process using a negative photoresist according to an embodiment of the invention.

FIGS. 9a-9b illustrate drawn CAD data and the resulting reticle pattern using a negative photoresist manufacturing process according to an embodiment of the invention.

### DETAILED DESCRIPTION

Embodiments of a system and method for chrome cut-out regions on a reticle are described. In the following description, numerous specific details are set forth. However, it is understood that embodiments of the invention may be practiced without these specific details. In other instances, well-known circuits, structures and techniques have not been shown in detail in order not to obscure the understanding of this description.

Reference throughout this specification to “one embodiment” or “an embodiment” means that a particular feature, structure, or characteristic described in connection with the embodiment is included in at least one embodiment of the invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

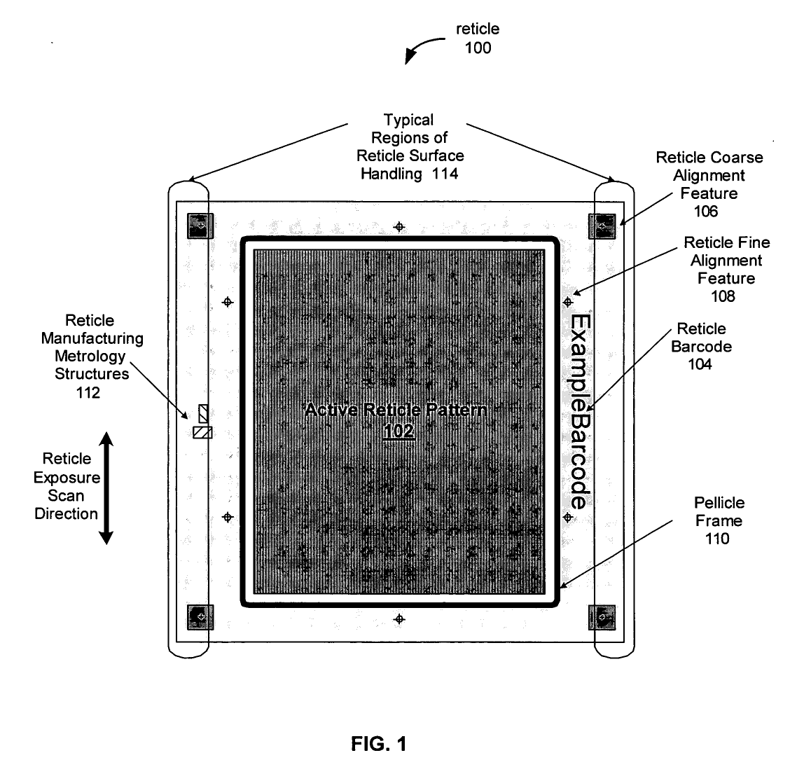

FIG. 1 illustrates a conventional reticle 100. The reticle 100 includes an active reticle pattern 102 to be exposed on wafers. The reticle may also include one or more features for the manufacturing process being used. For example, the reticle may include one or more coarse alignment features 106 and one or more fine alignment features 108 to help reticle handling apparatuses position the reticle. The reticle may include a barcode 104 to identify the reticle. The reticle may also include a pellicle attached to the surface to shield the reticle from particles. The pellicle frame 110 is shown in FIG. 1. Other reticle manufacturing structures, such as 112, may be placed on the reticle according to the manufacturing process used with the reticle. FIG. 1 also illustrates typical regions of reticle surface handling 114. These regions of the reticle typically come in contact with an apparatus that handles or supports the reticle during transport, storage, or semiconductor manufacture processing.

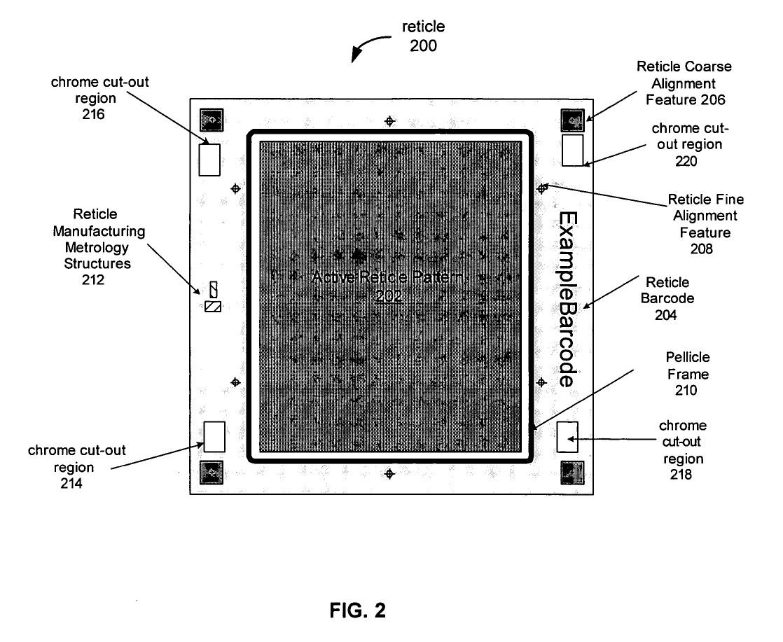

FIG. 2 illustrates a reticle 200 according to an embodiment of the invention. Reticle 200 includes one or more chrome cut-out regions, such as 214-220, located where a reticle handling or support surface may come into contact with the reticle. These chrome cut-out regions on the chrome surface of the reticle become clear or chrome-free after reticle manufacturing. The location and size of these regions may be determined based on several factors, such as the manufacturing process used with the reticle, the size and locations of required features to be placed on the reticle, and the types of apparatuses used for transporting, storing, or handling the reticle. These apparatuses may include but are not limited to reticle storage pods and reticle carriers used for shipping and storing the reticle, reticle-handling robot arms used to handle the reticle, and reticle stage surfaces where the reticle is held in place during use. The manufacturing process and specifications of reticle handling or storage apparatus may be used to determine where regions of the reticle are being contacted, potentially causing contamination or physical damage to the reticle. This data may be used to determine the location and size of the cut-out regions for the reticle. The location and size of the cut-out regions may also be determined based on observation of areas of surface degradation on the reticles. The size of the cut-out regions may be larger than the actual reticle support or handling contact surface to allow for manufacturing tolerances of the support or handling apparatus and tolerances associated with accuracy and repeatability of reticle placement and contact.

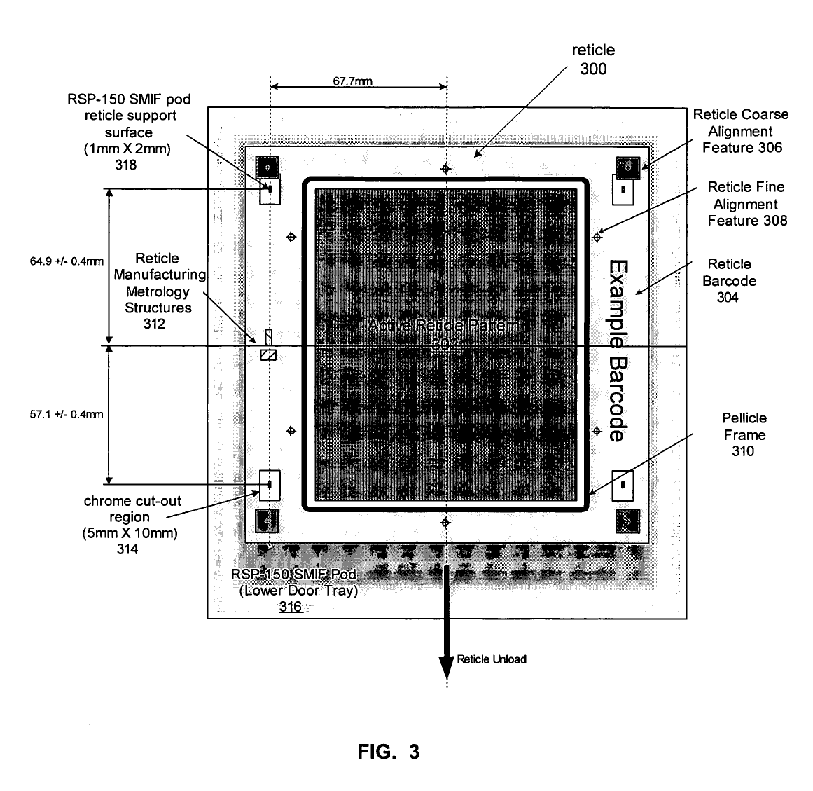

An example according to one embodiment of the invention of determining the location and size of chrome cut-out regions for a reticle 300 that comes in contact with a reticle Standard Manufacturing Interface (SMIF) pod lower door surface 316 will now be discussed for illustrative purposes with respect to FIG. 3. In this example, the 150 mm reticle 300 is illustrated from a top-down view as the reticle rests chrome-side down on top of an underlying reticle SMIF pod (RSP-150) lower door tray 316. The E11 Standard Equipment and Materials International (SEMI) specification for RSP-150 mechanical dimensions indicates that the critical dimensions of the locations of the four SMIF pod lower door reticle support contact surfaces with respect to the reticle center are: length/width is 1 mm in the X-dimension and 2 mm in the Y-dimension, horizontal displacement of all four contact surfaces is 67.7 mm in the X-dimension (E111 dimension of x245), vertical displacement of the upper two contact surfaces is 64.9±0.4 mm (E111 dimensions of y234−y228), and vertical displacement of the lower two contact surfaces is 57.1±0.4 mm (E111 dimensions of y233+y228). Therefore, cut-out regions such as 314 are placed in these four contact surface positions. Since the reticle support contact surfaces such as 318 are 1 mm by 2 mm, in order to allow for manufacturing tolerances of the support or handling apparatus and tolerances associated with accuracy and repeatability of reticle placement and contact, the cut-out regions may have a larger size, such as 5 mm by 10 mm, as shown in FIG. 3.

The determined location and size of the cut-out regions may overlap one or more required features of the reticle. In this case, the cut-out regions may be moved, resized, or reshaped to avoid conflict with the required features. For example, in FIG. 3, two of the four cut-out regions 314 overlap a reticle coarse alignment feature 306. Therefore, the cut-out regions may be reshaped to avoid cutting out the overlapping regions. By placing cut-out regions in the four locations where the SMIF pod contacts the reticle, potential contamination and surface degradation of the reticle is reduced. The location and size of the cut-out regions for any type of reticle handling or storage apparatus may be determined in a similar manner. The location and size of the cut-out regions may also be determined based on observation of areas of surface degradation on the reticles.

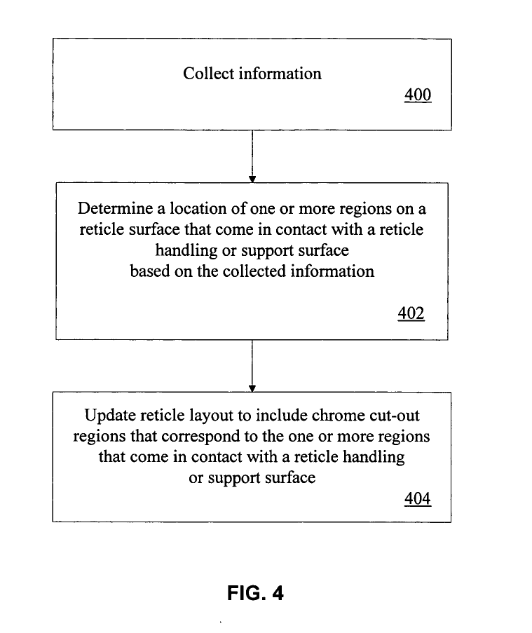

FIG. 4 illustrates a method of design according to one embodiment of the invention. At 400, information is collected. This information may include lithography equipment supplier's and mask shop's required reticle features and placement rules on the reticle substrate, the reticle manufacturing process to be used (such as whether a positive or negative photoresist will be used), the surface areas where reticle chrome surface handling contact could be made by the lithography equipment, and the design dimensions of the reticle handling apparatuses that are generating the chrome surface degradation. At 402, a location of one or more regions on a reticle surface that come in contact with a reticle handling or support surface is determined based on the collected information. In one embodiment, a size of each region is also determined. At 404, the layout of the reticle is updated to include one or more cut-out regions that correspond to the one or more regions that have been determined to come in contact with the reticle handling or support surface.

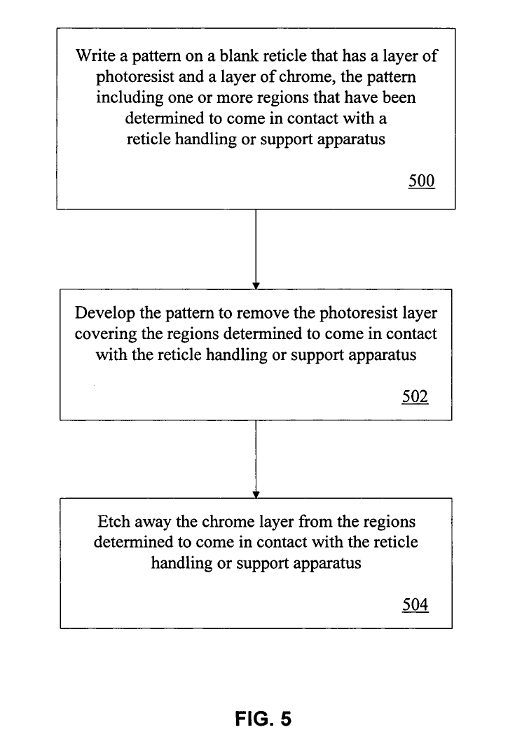

FIG. 5 illustrates a method of manufacturing according to one embodiment of the invention. At 500, a pattern is written on a blank reticle. The blank reticle has a layer of photoresist, which may be positive or negative, and a layer of chrome. The reticle pattern includes one or more cut-out regions that have been determined to come in contact with a reticle handling or support apparatus in additional to any required reticle manufacturing, equipment supplier, or active region patterns. This determination may be made according to the method discussed above with respect to FIG. 4. The pattern may be written on the blank reticle by an E-beam machine, a laser writer, or other reticle writing apparatus. At 502, the pattern is developed to remove the photoresist layer covering the regions determined to come in contact with the reticle handling or support apparatus. In one embodiment, the regions exposed during the writing of the pattern will be soluble in certain chemicals and may wash away during the development of the pattern. At 504, the chrome layer is etched away from the regions determined to come in contact with the reticle handling or support apparatus. After designing and manufacturing the reticle in the above manner, the correct positioning of the cut-out regions may be verified.

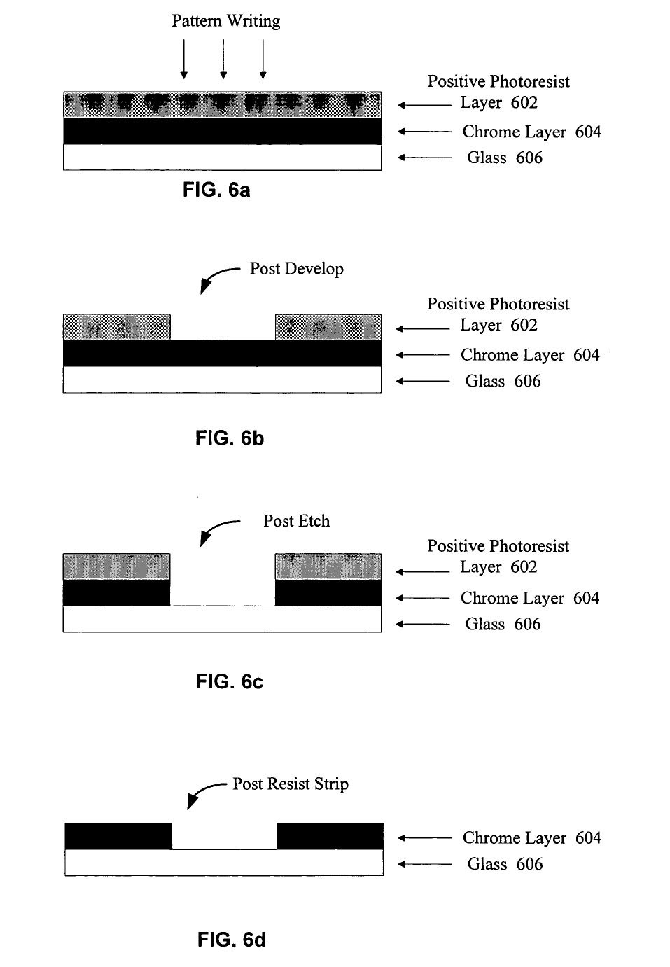

FIGS. 6a-6d illustrate a reticle in various stages of a manufacturing process using a positive photoresist according to an embodiment of the invention. FIG. 6a illustrates a blank reticle with three layers: a positive photoresist layer 602, a chrome layer 604, and a glass layer 606. As described in the manufacturing process of FIG. 5, a pattern is written on the blank reticle which includes one or more cut-out regions that have been determined to come in contact with a reticle handling or support apparatus. The written regions, which include the regions that have been determined to come in contact with a reticle handling or support apparatus, are exposed and developed to remove the positive photoresist layer and reveal the underlying chrome layer, as shown in FIG. 6b. The chrome layer is then etched away to reveal the clear glass layer, as shown in FIG. 6c. The positive photoresist layer may then be stripped to reveal the patterned chrome layer, as shown in FIG. 6d.

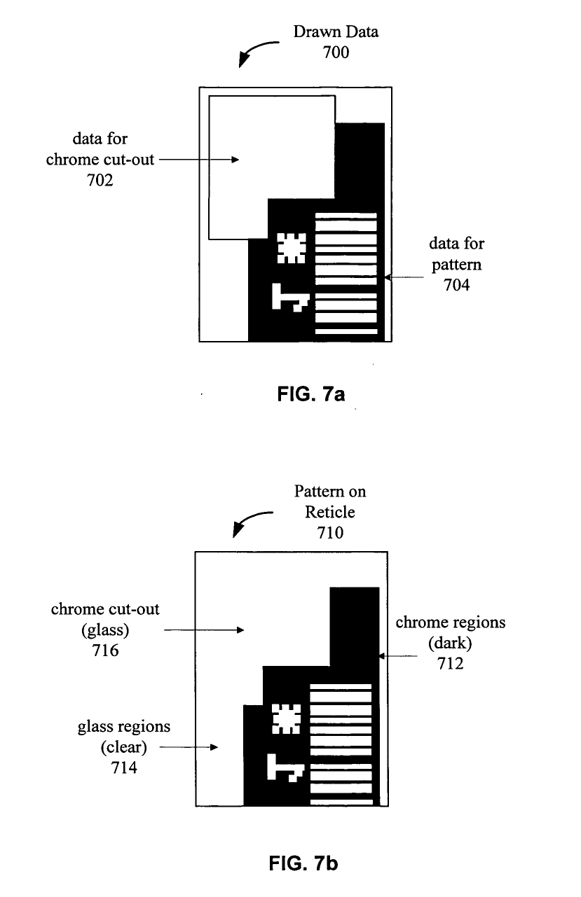

FIG. 7a illustrates the drawn computer-aided design (CAD) data 700 of patterns for a reticle using a positive photoresist manufacturing process according to an embodiment of the invention. As shown, there is data for a pattern 704 that includes a bar code and other required features. The data for the chrome cut-out 702 has an irregular shape to avoid conflict with the pattern 704. During the manufacturing process, as described above with respect to FIG. 6, the drawn areas, including the chrome cut-out regions, are exposed on the reticle chrome substrate's photoresist. These exposed areas are then developed to reveal the underlying chrome, which is then etched away. The resulting reticle pattern 710 is shown in FIG. 7b. As shown, the drawn regions, including the chrome cut-out regions 716, are clear (glass/chrome-free regions 714), while the undrawn areas are dark (chrome regions 712).

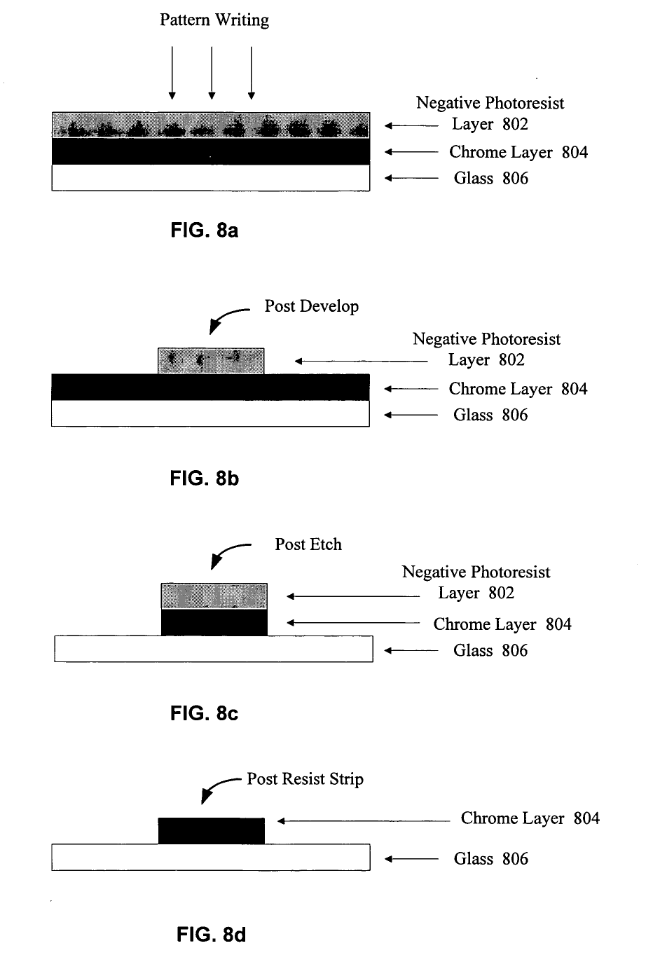

FIGS. 8a-8d illustrate a reticle in various stages of a manufacturing process using a negative photoresist according to an embodiment of the invention. FIG. 8a illustrates a blank reticle with three layers: a negative photoresist layer 802, a chrome layer 804, and a glass layer 806. As described in the manufacturing process of FIG. 5, a pattern is written on the blank reticle. The unwritten regions, which include the regions that have been determined to come in contact with a reticle handling or support apparatus, are exposed and developed to remove the negative photoresist layer and reveal the underlying chrome layer, as shown in FIG. 8b. The chrome layer is then etched away to reveal the clear glass layer, as shown in FIG. 8c. The negative photoresist layer may then be stripped to reveal the patterned chrome layer, as shown in FIG. 8d.

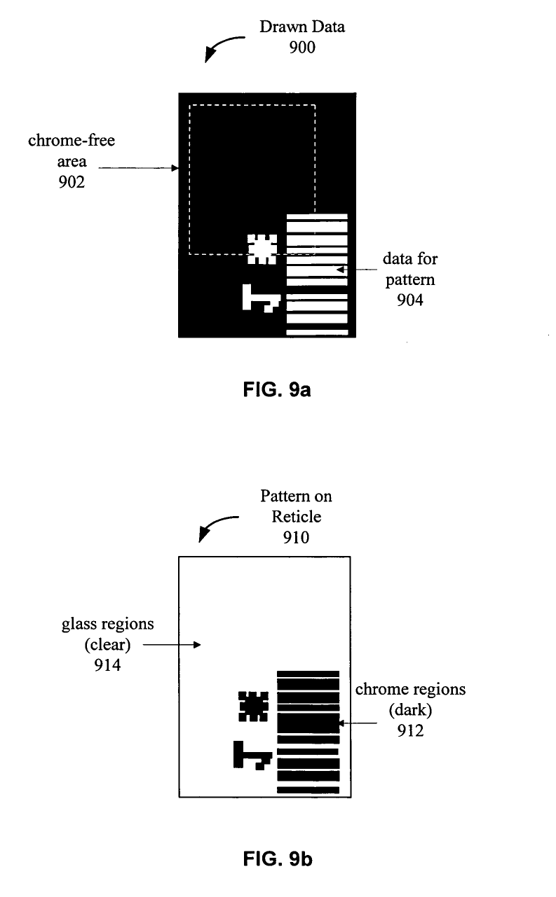

FIG. 9a illustrates the drawn computer-aided design (CAD) data 900 of patterns for a reticle using a negative photoresist manufacturing process according to an embodiment of the invention. As shown, the chrome-free area or cut-out region 902 (indicated by the dotted outline) conflicts with the data for required features 904. The required features take precedence over the chrome cut-out region. Therefore, the conflicting regions will be chrome regions even though they are part of the original chrome cut-out region 902. During the manufacturing process, as described above with respect to FIG. 8, the drawn areas are exposed on the reticle chrome substrate's photoresist. The unexposed areas, which include the chrome cut-out regions, are then developed to reveal the underlying chrome, which is then etched away. The resulting reticle pattern 910 is shown in FIG. 9b. As shown, the drawn regions are dark (chrome regions 912), while the undrawn areas, including the chrome cut-out regions, are clear (glass/chrome-free regions 914).

Thus, embodiments of a method and apparatus for chrome cut-out regions on a reticle surface positioned in areas that have been determined to come in contact with a reticle handling or support apparatus have been described. These chrome cut-out or chrome-free regions allow for the minimization of reticle chrome surface degradation and contamination.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

1. A method comprising:
determining a location of one or more regions on a reticle that come in contact with a reticle handling or support surface; and
generating a pattern to be written on the reticle, the pattern including one or more cut-out regions corresponding to the one or more regions that have been determined to come in contact with the reticle handling or support surface.

2. The method of claim 1, wherein determining a location of the one or more regions comprises determining a type of support surface used for the reticle.

3. The method of claim 1, wherein determining a location of the one or more regions comprises determining a type of carrier used for the reticle.

4. The method of claim 1, wherein determining a location of the one or more regions comprises determining a type of handling apparatus used for the reticle.

5. The method of claim 1, wherein determining a location of the one or more regions comprises determining a type of storage apparatus used for the reticle.

6. The method of claim 1, wherein determining a location of the one or more regions comprises determining a manufacturing process used with the reticle.

7. The method of claim 6, wherein determining a location of the one or more regions comprises determining one or more required features to be written on the reticle.

8. The method of claim 1, further comprising determining a size of each cut-out region.

9. The method of claim 1, further comprising writing the pattern on a reticle blank.

10. The method of claim 9, further comprising developing and etching the pattern to remove reticle surface chrome from the regions that have been determined to come in contact with the reticle handling or support surface.

11. A reticle comprising:
a circuit pattern to be exposed on a wafer; and
one or more chrome cut-out regions positioned where a reticle handling or support apparatus has been determined to come in contact with the reticle.

12. The reticle of claim 11, further comprising a barcode.

13. The reticle of claim 11, further comprising an alignment feature.

14. The reticle of claim 11, further comprising a pellicle to shield the reticle from particles.

15. The reticle of claim 11, further comprising a reticle manufacturing structure.

16. A method comprising:
writing a pattern on a blank reticle having a layer of photoresist and a layer of chrome, the pattern including one or more cut-out regions that have been determined to come in contact with a reticle handling or support apparatus;
developing the pattern to remove the photoresist layer and reveal the chrome layer in the regions determined to come in contact with the reticle handling or support apparatus; and
etching away the chrome layer to remove chrome from the regions determined to come in contact with the reticle handling or support apparatus.

17. The method of claim 16, wherein the layer of photoresist is positive and developing the pattern comprises exposing and removing the photoresist layer from the written regions to reveal the chrome layer.

18. The method of claim 17, wherein etching away the chrome layer comprises etching away the chrome layer from the written regions to reveal a glass layer of the reticle.

19. The method of claim 16, wherein the layer of photoresist is negative and developing the pattern comprises exposing and removing the photoresist layer from the unwritten regions to reveal the chrome layer.

20. The method of claim 19, wherein etching away the chrome layer comprises etching away the chrome layer from the unwritten regions to reveal a glass layer of the reticle.

21. The method of claim 16, wherein writing a pattern on a blank reticle comprises writing a pattern on a blank reticle via an E-beam machine.

22. The method of claim 16, wherein writing a pattern on a blank reticle comprises writing a pattern on a blank reticle via a laser writer.
